(19) United States
(12) Patent Application Publication
(10) Pub. No.: US 2013/0024811 A1
(43) Pub. Date: Jan. 24, 2013

(54) SYSTEM AND METHOD FOR WEB PAGE NAVIGATION

(71) Applicants: George B. Gleadall, Boca Raton, FL (US); Ronnie Paskin, Ft. Lauderdale, FL (US)

(72) Inventors: George B. Gleadall, Boca Raton, FL (US); Ronnie Paskin, Ft. Lauderdale, FL (US)

(73) Assignee: CBS Interactive, Inc.

(21) Appl. No.: 13/186,264

(22) Filed: Jul. 19, 2011

(51) Int. Cl. G06F 3/048

(52) U.S. Cl. 715/810

(57) ABSTRACT

A system and method for navigating web pages in a web site is disclosed. The system and method includes displaying a web page comprising navigation elements and non-navigation elements, receiving a first user input indicating a user interaction with a non-navigation element displayed on the web page and displaying a navigation menu at a location on the web page based at least in part on a location of the non-navigation element interacted with by the user, in response to receiving the first user input.

### BACKGROUND

Embodiments of the invention relate to navigating content in a web page and more particularly, to a system and method of controlling an interactive navigation menu on a website. When accessing the internet, a client device executes a software application program such as a browser. The browser application provides a link to the internet and also provides a user interface (GUI) in a browser window that can be viewed on a display on the client device. Users may interact with web pages shown in the browser window on the client device. Some web pages may include a stationary navigation menu at a specific location on a web page, many times at the top of the web page.

As internet connection speeds continue to increase and web page download times continue to decrease, moving between linked content and various web pages is virtually instantaneous. However, improvements to the traditional stationary web page navigation menu have been minimal. When a user scrolls to read various web page content, the stationary web page navigation menu scrolls out of view in many cases. This leads to a web page user being required to scroll back to the top of the web page to make further selections from the main web page navigation menu. Accordingly, current website navigation techniques act as a barrier to user interaction. For example, in many cases, not all web page content is initially viewable in a web browser window without having to take further action such as scrolling. Web content on a web page that is not initially viewable without further action is called “below the fold” content. Below the fold content devalues web page space from an advertising standpoint.

### SUMMARY

According to one exemplary embodiment, a method for navigating web pages is disclosed that includes the steps of displaying a web page comprising navigation elements and non-navigation elements, receiving a first user input indicating a user interaction with a non-navigation element displayed on the web page and displaying a navigation menu at a location on the web page based at least in part on a location of the non-navigation element interacted with by the user, in response to receiving the first user input.

According to another exemplary embodiment, one or more computer-readable media with machine-executable instructions stored thereon is disclosed such that when executed by one or more processors, instructions implement a method that includes displaying a web page comprising navigation elements and non-navigation elements, receiving a first user input indicating a user interaction with a non-navigation element displayed on the web page and displaying a navigation menu at a location on the web page based at least in part on a location of the non-navigation element interacted with by the user.

According to another exemplary embodiment the description includes an apparatus for navigating web pages comprising at least one memory and at least one processor configured to execute a script stored in the at least one memory to display a web page comprising navigation elements and non-navigation elements, receive a first user input indicating a user interaction with a non-navigation element displayed on the web page and display a navigation menu at a location on the web page based at least in part on a location of the non-navigation element interacted with by the user.

### BRIEF DESCRIPTION OF THE DRAWINGS

FIG. 1 is a schematic diagram of a network environment comprising a client-server architecture that is used to implement a navigation menu according to one embodiment of the invention;

FIG. 2 is a flow chart of a process for operating a navigational menu according to one embodiment of the invention;

FIG. 3 is a web page and the first tier of a graphical navigation menu according to one embodiment of the invention;

FIG. 4 is a web page and a graphical navigational menu displaying a first and a second tier according to one embodiment of the invention;

FIG. 5A is a schematic diagram of a display at a client device including a cursor according to one embodiment of the invention;

FIG. 5B is a schematic diagram of a display at a client device including a cursor according to another embodiment of the invention; and

FIG. 6 is a schematic diagram of a hierarchy of web pages within a website.

### DETAILED DESCRIPTION OF EXEMPLARY EMBODIMENTS

According to some embodiments, exemplary embodiments of the improved system and method disclose a simple, user-friendly navigation menu that follows a user around a web page to lower the barrier to user interaction and to increase the value of web page space.

Before describing in detail the particular improved system and method, it should be observed that the invention includes, but is not limited to a novel structural combination of data/signal processing components and communications networks, and not in the particular detailed configurations thereof. Accordingly, the structure, methods, functions, control and arrangement of components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

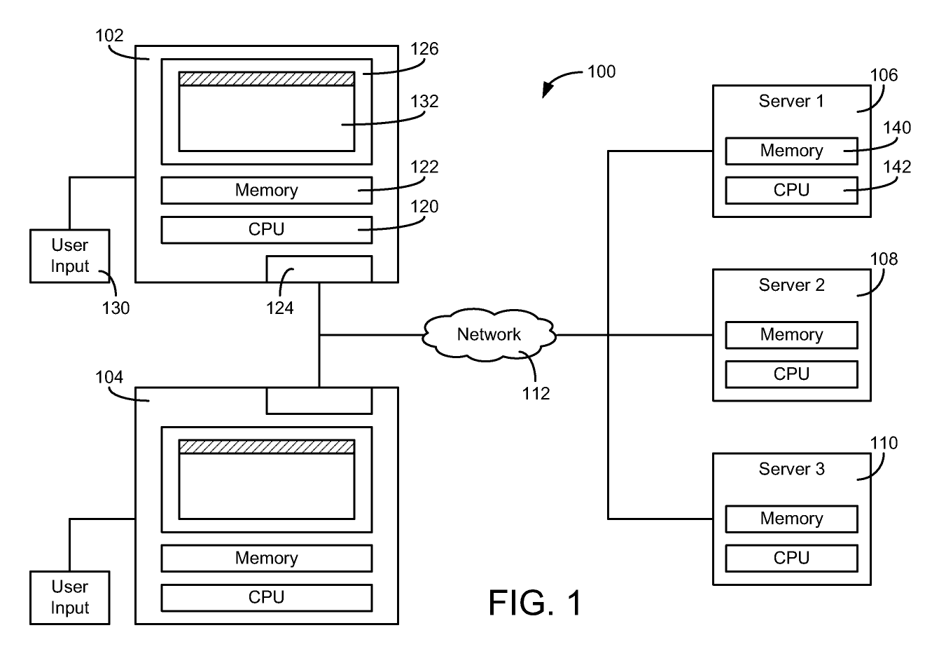

The network and computing environment in which the system and method for providing a web page navigation menu may be employed is described in FIG. 1. System 100 delivers content to client devices 102 and 104 according to one embodiment. The system 100 includes servers 106, 108 and 110 and client devices 102 and 104 coupled via a network 112 according to the exemplary embodiment shown in FIG. 1. Client devices 102 and 104 are computing devices that can include a processing circuit 120, a memory 122, a network interface 124, a user input element 130 as well as a display 126. The display 126 provides a browser window 132 which is provided on display 126 as a result of running a browser software application on client device 102. Browser software applications are well known in the art and include browsers such as Mozilla Firefox®, Google Chrome®, Apple Safari®, Netscape Navigator® or Microsoft Internet Explorer®. The browser window 132 displays internet content such as web pages from various web sites to facilitate user interaction with a web page. User input element 130 may comprise a mouse with a left button, a right button and a scrolling element. Although not illustrated, user input 130 may additionally comprise one or more user interface elements to receive an indication of user input including audio, mechanical, visual, motion or other input. The user interface may include a keyboard, a touch screen reception mechanism, a joystick, microphone, motion detector or any other input mechanism capable of receiving user input that allows user interaction with data in a browser window 132 shown in display 126.

Each client device can communicate with computing devices such as other client devices or servers 106, 108 and 110 through one or more networks represented by element 112. Network element 112 can comprise a local area network (LAN), wide area network (WAN), a telephone network, such as the Public Switched Telephone Network (PSTN), a wireless link, an intranet, the internet, or combinations thereof. Client devices 102 and 104 may be mainframes, minicomputers, personal computers, laptops, personal digital assistants (PDA), cell phones, and the like. Client devices are characterized in that they are capable of being connected to the network 112 through a network interface 124. Servers 106, 108 and 110 are typically computing devices having a processor 142 and a memory 140. The processing circuit 142 may comprise digital and/or analog electrical components (e.g., a microprocessor, application-specific integrated circuit, microcontroller, or other digital logic) configured to perform the functions described herein. The processing circuit may be a single server computer or a plurality of server computers, and may operate in a cloud computing environment, such as a shared, scalable computing environment. The memory 140 includes storage media, which may be volatile or non-volatile memory that includes, for example, read only memory (ROM), random access memory (RAM), magnetic disk storage media, optical storage media, flash memory devices and zip drives. Memory 140 may store data files associated with particular websites in a database format.

When a user of a client device 102 or 104 requests access to a server such as server 106 to view a website, a request is communicated to a server over network 112. For example, when a user enters a destination address in a web browser, a signal is transmitted from one of the client devices. The signal can include the destination address (e.g., address representing a web site and/or web page on a web site), a request (e.g., a request to view the a web page at a web site address) and a return address (e.g., address representing the client device that initiated the request). The request may include a cookie that includes data identifying the user and/or the user computer. The server 106 accesses a database in memory 140 that includes data related to various web pages. Using the address transmitted from a client device, server 106 can provide the client device 102 with the requested web page, which is communicated to the client device 102 over the network 112.

The web page received at a browser software application running on a client device may comprise a script or computer code that is executed by the browser's compiler or scripting engine. Scripts may comprise a single computer code or computing language or a combination of different computer codes or computing languages. Furthermore, scripts can be written in the same code as the browser code or a code different than the browser code. In addition, the script may be modified by an end user or may remain unmodified by an end user. The scripting language may comprise JavaScript, HyperText Markup Language (HTML), eXtensible HyperText Markup Language (XHTML) or any other suitable scripting language. When the scripting engine executes the web page script, the script is interpreted and loaded into browser window 132 to be displayed to a user in client device display 126. The script may be executed at a client device 102, at a server 106, 108, 110 or at both a client device and a server as shown, for example, in FIG. 1.

Some exemplary client side scripting languages include JavaScript and ActionScript which can be used with Asynchronous JavaScript and XML (AJAX), Dynamic HTML (DHTML) and Flash to implement multimedia effects such as sound, animation or any other aspect of web page presentation in browser window 132. Scripts executed at a web server are server side scripts and may include scripting languages such as Active Server Pages (ASP) and Java Server Pages (JSP). Server side scripts are executed by a scripting engine located at a server 106 rather than a client 102 and the results of the execution are returned to a client 102. The script executed in the web browser may also include remote scripting technology wherein the script can request additional information from a server 106 using hidden frame or XMLHttpRequests. For example, AJAX uses XMLHttpRequests to dynamically interchange content with the server-side database asynchronously without having to reload the currently presented page or otherwise interfering with the display and behavior of the existing page.

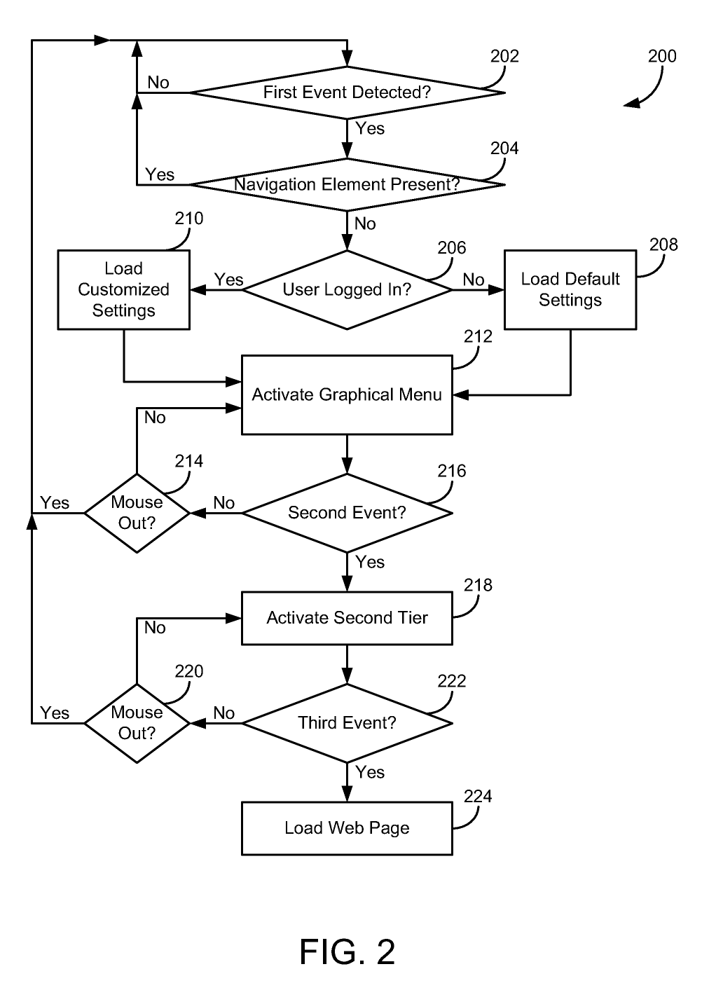

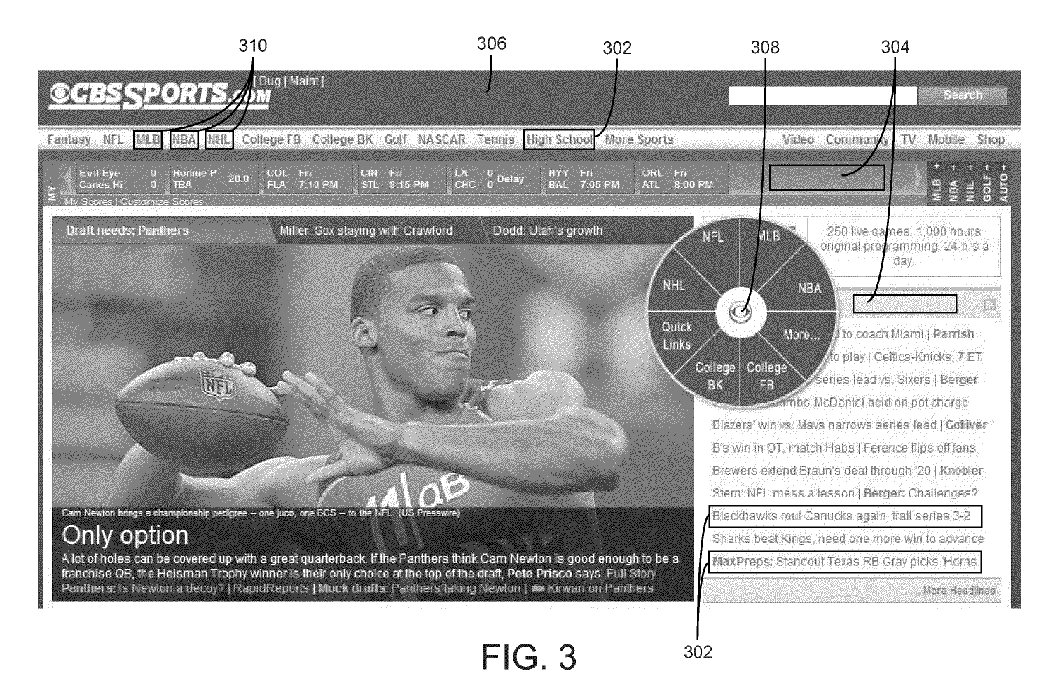

Referring to FIG. 3, processor 120 may execute the script received from server 106 to display web page 305 in browser window 132 on client device 102. The executed script may monitor user inputs received from a user input element 130 and display various responses to detected events characterized by user inputs. For example, a script received from server 106 may be stored in memory 122 and executed by processor 120 to implement the steps in process 200 as seen in FIG. 2.

Accordingly, a user can interact with the web page 306 in a browser 132 by entering various commands through user input element 130. For example, a user may transmit a left click event, right click event, hover or mouse out event, or a scroll event to the browser application running a script. Although a “left click event” or a “right click event” or a “mouse out event” corresponds to specific commands from a mouse, these events also correspond to various other input devices that can carry out the same functions a mouse can carry out. Accordingly, newer user input technology such as touch screen detection, speech recognition, etc. may also be used to transmit events to a client device 102. Accordingly, a “right click event” can also be performed by a user contacting a touch screen of with a predetermined duration and/or force. Furthermore, a “hover” event simply corresponds to an indication of a users desired location with respect to a web page and is not limited to events detected from a mouse. The users desired location with respect to a web page can be indicated on display 126 as a cursor, for example. Accordingly, one example of a hover event may be carried out by placing a cursor over an item or area without clicking on that item or area. Similarly, a “mouse out” event may correspond to an indication of a user moving a desired location away from an object on a web page. An example of a mouse out event is moving a cursor away from a menu on a web page. Both hover events and mouse out events can be produced by a touch screen input through detection of a dragging motion of a predetermined duration and force on a touch screen display. The browser software application stored in memory 122 and executed by processor 120 may be capable of detecting one or more of these events and displaying various responses to each of the events.

According to one embodiment, a navigation menu 308 can be displayed and interacted with by a user manipulating user input element 130. The navigation menu may be controlled according to a script written in JavaScript, XHTML or various other scripting languages. Web page 306 may be displayed in a browser window 132 at a client device 102 through the execution of client side scripting, server side scripting, remote scripting technologies or a combination of scripting methods. Graphical navigation menu 308 may also use AJAX to retrieve data stored at server 106 as described previously in response to user input from user input element 130. Techniques such as client side caching may also be implemented in the data retrieval and display process according to one embodiment. Client side caching allows client device memory 122 or a web browser running on client device 102 to temporarily store web site content such as web pages, images and web site addresses. Client side caching is advantageous in that it may reduce client-server communication time, reduced web page loading time, and/or reduce bandwidth consumption on network 112. For example, client side caching may be used to temporarily store previously visited web pages that can quickly be displayed in browser window 132 when a back button in browser window 132 is indicated, for example.

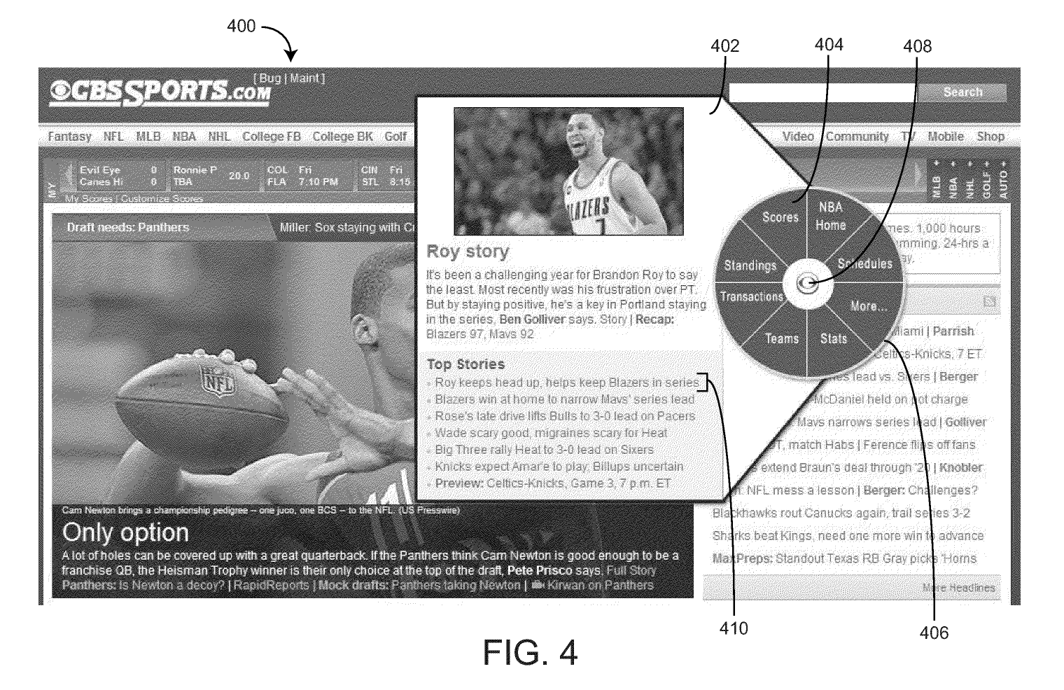

Referring to FIG. 3, a user may interact with navigation menu 308 to display a second tier 402 as shown in FIG. 4. Second tier navigation options may comprise navigation options or topics relating to one of the options in the first tier navigation menu 308. For example, a first tier navigation option may be “NBA” and the second tier navigation options may comprise scores, standings, schedules, etc. all relating to NBA teams and events. According to one exemplary embodiment, AJAX may be used to retrieve the second tier data so that second tier 402 can be quickly and seamlessly displayed in a browser window without having to reload web pages. Accordingly, in this embodiment, web page 306 does not need to be reloaded when a second tier is displayed on navigation menu 308 as shown in 406 in FIG. 4.

The various user interactions with the navigation menus 308 and 406 can cause the display of navigation menu 308 to be altered. In one embodiment, a second tier 402 can expand out from the navigation menu using animation such as Flash animation or any other audio or visual effects. Flash animation uses an object oriented computer code that may be implemented into a web page code to produce various effects in response to specified user input. Flash animation may be executed by a browser plug-in, such as Flash Player, for example. For a web browser that has a Flash Player plug-in, user interactions with a web page displayed in browser window 132 such as a mouse click, may cause an animated clip executed by a Flash Player to be displayed in the browser window. For example, if a web page code or script containing Flash code detects a predetermined user input such as cursor movement, the script may display an animation clip such as animation to alter the color, size, shape or placement of a graphical element such as a navigation menu 406 as shown in FIG. 4.

Referring to FIG. 2, before, during or after a web page 306 is displayed in browser window 132 according to the client-server process discussed previously, one or more steps of process 200 may be executed according to a script or other code executed by a browser or other application running on client 102. Process 200 is a method for providing and interacting with a graphical navigation menu that facilitates interaction between a user entering events through user input element 130 and a web page 306. Events received from user input element 130 may be detected by a script and may display various predetermined responses which may be displayed to a user in browser window 132 according to one exemplary embodiment. At step 202, the script running in a browser application monitors data received from user input element 130 to determine if a first event is detected. In one preferred embodiment, the first event is a left click event. However, various other events or commands received from user input element 130 may be designated as the first event. When a first event such as a left click on a web page is detected, process 200 determines if the left click event is associated with a web page navigation element which can include anchors, hyperlinks, applets, etc.

An example of a navigation element is element 310, which includes links to various other web pages or displayable content within the same web page. Non-navigation elements may be document object elements that are not associated with an anchor tag. Non-navigation elements may also be document object element without any other bound navigation, according to one exemplary embodiment. An example of a non-navigation element is element 304, which does not navigate a user to any additional data when indicated as a desired user location by user input element 130. The first event is a left click event according to a preferred embodiment because websites do not typically perform any interactive function when a user enters a left-click command on a non-navigation element. Accordingly, assigning the left click event a new functionality conveniently takes advantage of unused and available resources. In other embodiments, a non-navigation element may comprise any element which is not a navigation element, or an element which does not comprise a hyperlink.

Referring again to process 200 in FIG. 2, once a first event such as a left click is detected at step 202, step 204 determines if the first event corresponds to a location associated with a navigation element or a non-navigation element. If the first event is associated with a navigation element such as element 302, process 200 returns to step 202 to further monitor for a first event and the web page functions according to browser functionality unassociated with process 200. However, if the first event is associated with a non-navigation element such as elements 304, a navigation menu will be displayed at step 212. In one embodiment, the navigation menu may be displayed at a location based on the location of the first event according to one embodiment at step 212. The navigation menu 308 may appear on web page 306 at a coordinate associated with the first event or within a predetermined distance of the coordinate associated with the first event according to one embodiment. The navigation menu 308 may be near the first event click, in the vicinity of the first event click, or otherwise have a location determined based at least in part on the first event click. In one embodiment, the navigation menu is circular and divided into equally sized first tier segments with a circular center icon. Navigation menu 308 may comprise any other shape including a square, oval, triangle, or any other shape or polygon. Navigation menu 308 may also take forms other than standard shapes such as the form of a logo, object or outline. The circle presented to the user on web page 306 may be presented to a user using Flash or other type of animation or effects.

Process 200 may also determine if a user is logged in at step 206. Determining if a user is logged in allows process 200 to determine if navigation menu 308 can be customized according to previously recorded user settings. For example, a user may save settings on a particular website indicating a desire to only have particular categories such as NBA, NFL and MLB or other data categories for example, included in the first tier segments, second tier segments, and/or other segments. Furthermore, a user may also record preferences on the style, color or animation of the graphical navigation menu that can be retrieved when the user logs in to the website. Accordingly, step 206 determines if a customized navigation menu or a default navigation menu is displayed at step 212 according to one exemplary embodiment.

Once the navigation menu 308 is displayed at step 212, process 200 further monitors input signals received from user input element 130 to determine if a second event has occurred at step 216 which may be a same or different event than the first event (e.g., mouse click, touch screen input, hover, etc). Other events may include the passage of a predetermined period of time. According to one exemplary embodiment, the second event is a hover event or mouse over event. For example, if a user moves a cursor over one of the first tier segments such as the NBA segment, a second tier containing further data associated with the NBA segment is displayed at step 218 as shown by element 402 in FIG. 4. The segment may include navigation elements such as link 410. The second tier may also include advertising received from a first server 106 associated with the website displayed in browser window 132 or alternatively may be received from a second advertising server such as server 108. Furthermore, the advertising may be customized based on customized settings loaded in step 210.

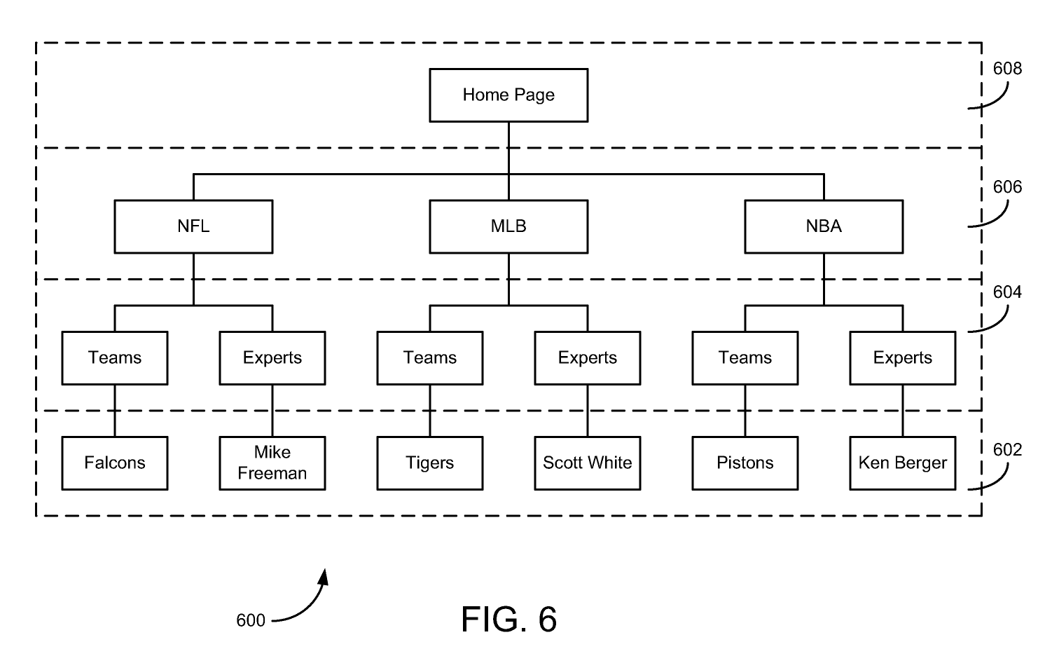

Additionally, the first and second tier data may correspond to levels of a website hierarchy or tree structure as shown in FIG. 6. For example, the first tier may consist of first level categories 606 including NFL, MLB and NBA categories while the second tier may include a lower level of categories 604 associated with one of the first tier segments according to one embodiment. Furthermore, although process 200 only indicates two tiers, a third or more tiers may be implemented to accommodate additional levels of web page hierarchy such as level 602.

Once second tier 402 is displayed by the second event at step 218, process 200 monitors data from input element 130 to determine if a third event has occurred at step 222. The third event may comprise a left click or right click event or any other event indicating a navigation element included in the second tier such as link 410. Once a third event such as selecting a navigation element in the second tier occurs at step 222, data associated with the navigation element can be retrieved and displayed in browser window 132 at step 224. The data may be retrieved by placing a request to the website web server such as server 106. The web page may be reloaded as a result of step 224 or the content of a current web page may simply be replaced with new content without any reloading required according to any suitable method.

As shown by steps 214 and 220, once the navigation menu including a first tier 308 or the navigation menu with a second tier 406 are displayed in browser window 132, the browser software application may detect events that remove the graphical navigation menu from the web page according to one exemplary embodiment. The event that triggers the removal of navigation menu 308 or 406 from browser window 132 may be a hover or mouse out event. In this embodiment, if an indication of a desired user location such as a cursor is moved to a web page location outside of the location of the first tier or the location of the first and second tier, the navigation menu may be deactivated and no longer displayed on the web page. At this time process 200 returns to step 202 as shown in FIG. 2 according to one embodiment. Although deactivation of the navigation menu may be triggered by a mouse out event as shown in FIG. 2, any other user indication outside of the navigation menu location such as a right click or left click event received by the browser software application may be used as the navigation menu deactivation event. Furthermore, various steps in process 200 including steps 214 and 220 may be customized by the user settings loaded at step 210 in the case that a user logs in at step 206. In addition, the log in step 206 may be located at any stage of process 200 to determine if the navigation menu 308 is customized or default. Furthermore, the processes in FIG. 2 may be rearranged and performed in different orders, and the processes may each be optional in different embodiments.

Another feature of navigation menu 406 is central region 408 shown as a circular region with a defined perimeter in FIG. 4. Central region may be of any shape or form. According to one embodiment, selecting central region 408 displays navigation between a hierarchy of web pages included in a website. For example, web page 400 is the home page of a website corresponding to a first level 608 shown in FIG. 6. FIG. 6 further depicts a portion of a website hierarchy 600 with branches extending form the highest level 608 to lower levels 606, 604 and 602. Lower levels may include a variety of detailed web pages devoted to a the subject of an associated web page from a lower level.

For example, referring to FIG. 4, a user may select the NBA first tier segment by transmitting a second event. When a user selects navigation link 410 by transmitting a third event, browser window 132 will display web page content associated with the selected link 410. If a user then displays a navigation menu on the web page associated with the selected link 410 and further indicates center region 408, the web page will be navigated from the current web page to a lower level web page in website hierarchy 600. The web page may alternately be navigated to a higher level web page in the website hierarchy 600. The indication may be in the form of a right click, left click, hover or any other event associated with a user indication. Accordingly, if the current web page is the “pistons” web page shown in level 602 in FIG. 6, a user may display the navigation menu on the “pistons” page and indicate the center region 408 to navigate to a lower level page “teams.” This process may be repeated at the teams page in level 604 in order to navigate to the NBA page in level 606 and the home page 608.

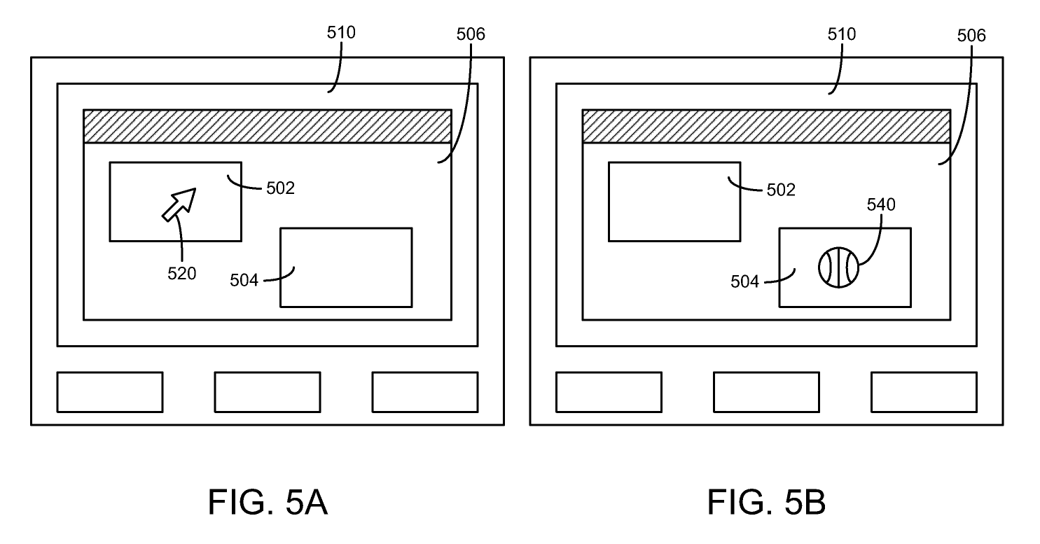

A further aspect of one embodiment of the navigation menu is shown in FIGS. 5A and 5B in a browser window 506 on the display 510 of a client device. According to one exemplary embodiment, the graphical representation of a pointing device such as a cursor can be altered to indicate a particular location on a website. For example, in FIGS. 5A and 5B area 502 corresponds to a navigation element while area 504 corresponds to a non-navigation element. In this embodiment, cursor 520 retains a default shape such as an arrow when hovered over navigation elements but is altered to a new shape as shown by element 540. The new shape may take any form and may be selected according to user specifications after a user log in has occurred. Additionally, the new shape may be transitioned to by animation such as Flash animation or any other visual or audio effect. Accordingly, this allows a user to be aware of what locations will result in a navigation menu activation if a first event such as a left click is received from user input element 130.

It should be noted that the server is illustrated and discussed herein as having various modules which perform particular functions and interact with one another. It should be understood that these modules are merely segregated based on their function for the sake of description and represent computer hardware, circuits and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices and client devices can be PCs, mobile phones, handsets, servers, PDAs or any other device or combination of devices which can carry out the disclosed functions in response to computer readable instructions recorded on media. The phrase “computer system” or “computing devices”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A method of providing a graphical navigation element on a web page of a web site, comprising:
displaying a web page comprising navigation elements and non-navigation elements;
receiving a first user input indicating a user interaction with a non-navigation element displayed on the web page; and
displaying a navigation menu at a location on the web page based at least in part on a location of the non-navigation element interacted with by the user, in response to receiving the first user input.

2. The method of claim 1, wherein the navigation menu comprises a first tier having a perimeter divided into a plurality of first tier segments and a second tier comprising at least one selectable link for further navigation on the web site that is displayed in response to receiving a second user input indicating one of the plurality of first tier segments.

3. The method of claim 2, wherein the steps of receiving the first user input, receiving the second user input, displaying the navigation menu and displaying the second tier are performed by executing a script received from a computing device.

4. The method of claim 2, wherein the second tier is located entirely outside the perimeter of the first tier, the first user input is a left click event and the second user input is a hover event.

5. The method of claim 3, wherein the script is executed by a scripting engine in a browser software application stored in a memory wherein the browser software application provides a browser window displaying a web page associated with a website.

6. The method of claim 4, wherein a center region having a perimeter is located entirely within the perimeter of the first tier further wherein receiving a user input indicating the center region displays data associated with a higher or lower level web page in the browser window according to a website hierarchy.

7. The method of claim 2, further comprising:
receiving user identification information;
requesting user data associated with the user identification information from a computing device;
receiving user data associated with the user identification information from a computing device;
customizing at least one of the plurality of first tier and second tier segments based on at least one of:
the received user identification information;
user preferences; and
user activity.

8. The method of claim 2, wherein displaying at least one of the navigation menu and the second tier comprises displaying at least one of a visual effect associated with the navigation menu and a visual effect associated with the second tier.

9. The method of claim 5, wherein the memory is located at a client device and the browser window is displayed in a client device display.

10. The method of claim 9, wherein the script comprises JavaScript.

11. The method of claim 9, wherein the second tier displays advertisement data received from a computing device.

12. The method of claim 1, wherein a displayed cursor is altered to indicate locations of the web page that are associated with non-navigation elements.

13. The method of claim 2, further comprising:
receiving a third user input indicating one of the at least one selectable links; and
displaying a new web page in the browser associated with the indicated selectable link in response to receiving the third user input.

14. One or more computer-readable media with machine-executable instructions stored thereon and when executed by one or more processors implements a method comprising:
displaying a web page comprising navigation elements and non-navigation elements;
receiving a first user input indicating a user interaction with a non-navigation element displayed on the web page; and
displaying a navigation menu at a location on the web page based at least in part on a location of the non-navigation element interacted with by the user.

15. The computer readable medium of claim 14, wherein the navigation menu comprises a first tier having a perimeter divided into a plurality of first tier segments and a second tier comprising at least one selectable link for further navigation on the web site that is displayed in response to receiving a second user input indicating one of the plurality of first tier segments.

16. The computer readable medium of claim 14, further comprising:
receiving user identification information;
requesting user data associated with the user identification information from a computing device;
receiving user data associated with the user identification information from a computing device; and
customizing at least one of the plurality of first tier and second tier segments based on at least one of:
the received user identification information;
user preferences; and
user activity.

17. An apparatus for navigating web pages comprising:
at least one memory; and
at least one processor configured to execute a script stored in the at least one memory to:
display a web page comprising navigation elements and non-navigation elements;
receive a first user input indicating a user interaction with a non-navigation element displayed on the web page; and
display a navigation menu at a location on the web page based at least in part on a location of the non-navigation element interacted with by the user.

18. The apparatus of claim 17, wherein the navigation menu comprises a first tier having a perimeter divided into a plurality of first tier segments and a second tier comprising at least one selectable link for further navigation on the web site that is displayed in response to receiving a second user input indicating one of the plurality of first tier segments.

19. The apparatus of claim 17, wherein the at least one processor is configured to execute a script stored in the at least one memory to further:
receive user identification information;
request user data associated with the user identification information from a computing device;
receive user data associated with the user identification information from a computing device; and
customize at least one of the plurality of first tier and second tier segments based on at least one of:
the received user identification information;
user preferences; and
user activity.

20. The apparatus of claim 17, wherein the script is executed by a scripting engine in a browser software application stored in the at least one memory in a client device further wherein the browser software application provides a browser window displaying a web page associated with a website on the display of the client device.
